(19) United States
(12) Patent Application Publication
(10) Pub. No.: US 2019/0143213 A1
(43) Pub. Date: May 16, 2019

(54) Method for Organizing Pictures and Videos within a Computing Device

(71) Applicant: Gustav Pastorino, Fremont, CA (US)

(72) Inventor: Gustav Pastorino, Fremont, CA (US)

(21) Appl. No.: 15/815,618

(22) Filed: Nov. 16, 2017

(51) Int. Cl. A63F 13/46; A63F 13/80; G06F 17/30; G06F 3/0482

(52) U.S. Cl. CPC A63F 13/46; G06F 3/0482; G06F 17/30126; A63F 13/80

(57) ABSTRACT

A method for organizing pictures and videos within a computing device implemented through a binary organization process or a categorized organization process. Each process graphically displays at least one media content from a plurality of stored media contents that are stored within the computing device. Then, an input command from a user graphically capture the at least one media content into a selected folder. The process of graphically displaying and capturing the media content is then applied to the media contents as long as the user is able to continuously capture the media content without an interruption or the stored media contents are completely captured. A scoring system calculates a total score for the plurality of stored media contents and posts a final score in social gaming network to create an atmosphere of competition to increase the excitement of the productive and memory enhancing games.

### FIELD OF THE INVENTION

The present invention relates generally to the field of optimizing storage space of a computing device. More specifically, the present invention is a method of organizing pictures and video within a computing device through gamification thus optimizing the storage space of the computing device.

### BACKGROUND OF THE INVENTION

Mobile phones and many other electronic devices are able to capture and store pictures and video using a built-in digital camera and internal storage. Especially with the convenience of the digital camera phone, users tend to capture large numbers of pictures and recordings over the course of their lives. For example, users normally take multiple shots of the same moment, or might repeatedly take pictures of the same content in order to capture the perfect picture. However, they often forget to delete the unnecessary picture files afterward, or just don't have a convenient time to sort their photos from the ones they don't want. Maybe they just don't make the time. It's a tedious process, and can only be done by the owner of the device since the photos are personally meaningful.

The major downside of having a lot of pictures and recordings stored on the mobile phone specifically is that those pictures and recordings take up a considerable amount of storage space, and as a result limit essential functionality. This stress on individual devices is most noticed once storage memory has reached capacity, and the functionality of the phone will start to diminish since system resources are taxed by the lack of available free storage space. Processing any data on a device requires a small, but limiting amount of free storage. When this happens to the mobile phone or other device, it forces the user to deal with the issue when it's not very convenient at all, and it seems like an inconvenient chore. And if the phone is backed up to cloud storage, the limitation turns into added costs since cloud storage comes at a price.

The present method of organizing pictures and videos within a computing device solves this problem, and does it with a human touch; with gamifying. Gamification is used here to create a fun environment for the user to sort these photos and thus solves this predicament of lost and cluttered storage space. The method is a game with specific means to aid the user in this process.

Freeing up computer storage memory is the main focus of this invention, but there's also an added benefit to the user's own biological memory. Since the advent of smart devices, picture sorting in real, physical photo albums has subsequently become an antiquated pastime. In a 2009 study, Martini and Maljkovic firmly established that the total time of exposure to a pictographically captured memory was the determining factor in the likelihood of memory retention. In subjects, the longer the exposure to the picture the better a subject performed on a memory test. In parallel with this, the exposure time of reviewing personal photographs and photo albums is how memories are retained of life events. These memories are organized to create a narrative, or a life story. With an opportunity to review any personally relevant photo album, this is an opportunity to increase exposure time to the related captured experiences, which helps to retain those memories even better. Because most people are overwhelmed by the task of sorting through their digital photo albums, they are neglecting to review and add time to the experiences of their past, and aren't reaping the benefits for their own memory recollection. The present invention reawakens a time when people were closer to themselves, by giving a means to temporally revisit and review photographically captured experiences.

Photographic content has migrated digitally to electronic device storage or cloud storage, but how people process photographic content is no different from book version photo albums. The big difference is that digitally stored content is now much easier to categorize, but this has given rise to the now pressing question: “Which method will make this activity of categorizing and organizing digital pictures in our devices not the most boring and neglected activity in the world?”, and “What would make it enjoyable?” And so, like a physical board-game to improve memory, the answer is with gamification. By gamifying digital photograph organizing, the present invention proposes the most effective means; by allowing the user to separate unwanted pictures and videos, categorizing the most meaningful photos and videos, simultaneously enabling review of long-term memories to improve memory recall of life events, and making it enjoyable. The proposed method in the present invention resultantly provides an opportunity for the user to perform a memory review, enhancing and exercising long-term memory through an enjoyable photographic memory review session.

It is the objective of the present invention to provide a method for organizing pictures and video within a computing device through gamification. Since the present invention implements this organizing process through a gamified method, the task will be more rewarding then simply organizing of a photo album, and will likely increase the chance a user will complete the task. As a result of the gameplay, users are able to keep and organize pictures and videos that are important, and delete the unnecessary pictures and videos. Due to the deletion of multitude of unwanted digital photos, the user will save electronic memory storage space on their devices, and in turn save money with cloud storage expenses. Lastly, current biological memory studies suggest that memory retention is related to the duration of time that a pictographic experience is viewed (Martini, Maljkovic, 2009). With the present invention, the biological memory of users today will experience improvement when all of these photos in our digital storage gets all sorted. In sum, the present invention aids the user by freeing up storage space of the respective computing device to optimize its functionality, while also strengthening biological memory by providing the user an enjoyable method to review personal photos and video. The present invention seeks to categorically preserve all of the user's preferred photographically captured digital memory and personal memories for the benefit of the user to find and remember experience, for the benefit of the user's personal electronic device functionality, and to lower the users cloud storage costs.

### BRIEF DESCRIPTION OF THE DRAWINGS

FIG. 1 is a basic flow chart illustrating the overall method of the present invention.

FIG. 2 is a basic flow chart illustrating the media content, the plurality of folders, and the pair of folders within the overall method of the present invention.

FIG. 3 is a basic flow chart illustrating the downward advancement of the media content and the corresponding input command for the media content within the overall method of the present invention.

FIG. 4 is a basic flow chart illustrating the upward advancement of the media content and the corresponding input command for the media content within the overall method of the present invention.

FIG. 5 is a basic flow chart illustrating the left to right advancement of the media content and the corresponding input command for the media content within the overall method of the present invention.

FIG. 6 is a basic flow chart illustrating the right to left advancement of the media content and the corresponding input command for the media content within the overall method of the present invention.

FIG. 7 is a basic flow chart illustrating the scoring system within the overall method of the present invention.

FIG. 8 is a basic flow chart illustrating the game completion status within the overall method of the present invention.

FIG. 9 is a basic flow chart illustrating the game over status within the overall method of the present invention.

### DETAIL DESCRIPTIONS OF THE INVENTION

All illustrations of the drawings are for the purpose of describing selected versions of the present invention and are not intended to limit the scope of the present invention.

The present invention is a method for organizing pictures and videos within a computing device through gamification. As a result, the present invention is able to fully organize stored pictures and videos while isolating unwanted pictures and videos for deletion and freeing up storage space within the computing device. The present invention is implemented through the computing device, wherein the computing device can be a personal computer, a smartphone, a tablet computer, virtual reality headset, augmented reality headset, or any other similar electronic devices. The pictures and videos are hereinafter explained as a plurality of stored media contents. In other words, the computing device that is managed by a user account includes the plurality of stored media contents so that the present invention can be utilized to organize the plurality of stored media contents.

In order for someone to access the present invention, a user of the present invention first have install the application. Alternatively, the user may be asked to create the user account through a sign-up process of the present invention or log-in with an existing social network profile so that the present invention can grant access to the plurality of stored media contents. In order to create the user account, a user needs to provide an email address and a password. Once the user uploads the email and the password, the present invention sends an activation notification to the respective email address. The user can then access the present invention through the activation notification, wherein the present invention prompts the user to create the user account with general information, including, but is not limited to, a full user name, a user gender, and a user image.

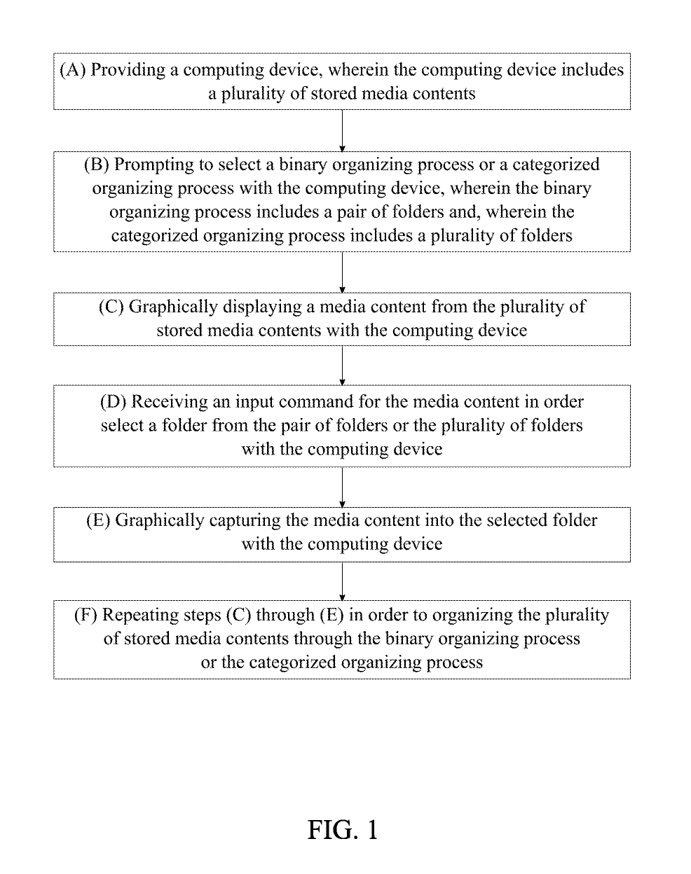

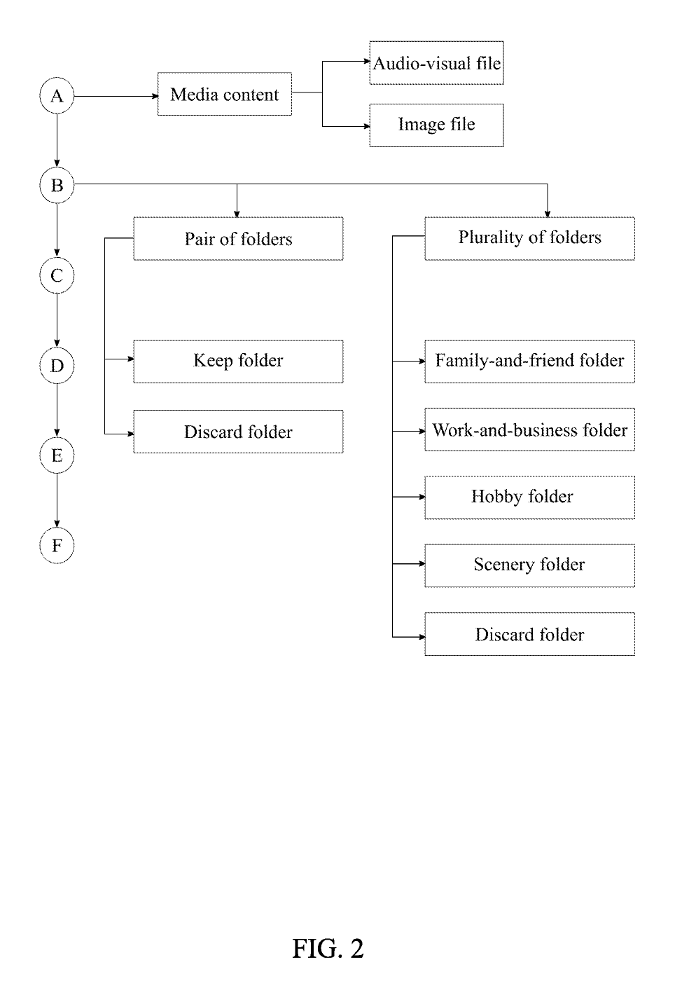

Once the access is granted to the present invention, the user account is prompted to select a binary organizing process or a categorized organizing process with the computing device as shown in FIG. 1. The two different organizing processes allow the user account to decide how the plurality of stored media contents should be organized within the computing device. More specifically, the binary organizing process includes a pair of folders so that the plurality of stored media contents can be organized into the pair of folders that is identified as a keep folder and a discard folder as shown in FIG. 2. For example, the keep folder functions as a destination folder to compile the plurality of stored media contents that is important to the user account. The discard folder functions as a destination folder to compile the plurality of stored media contents that is not important to the user account. More specifically, the categorized organizing process includes a plurality of folders so that the plurality of stored media contents can be organized into the plurality of folders that identified is a family-and-friend folder, a work-and-business folder, a hobby folder, a scenery folder, and a discard folder as shown in FIG. 2. For example, the plurality of stored media contents that is important to the user account can be distributed into the family-and-friend folder, the work-and-business folder, the hobby folder, and the scenery folder upon the selection of the user account. The plurality of stored media contents that is not important to the user account can be compiled into the discard folder upon the selection of the user account.

In reference to FIG. 1-2, once the binary organizing process or the categorized organizing process is selected through the computing device, the present invention graphically displays a media content from the plurality of stored media contents with the computing device. Since pictures and videos are generally stored within the computing device, the media content can be an image file or an audio-visual file within the present invention. The displaying of the media content can be executed with two different methods, a vertical direction and a horizontal direction, so that the present invention is able to receive an input command for the media content from the user account. The input command then enables the present invention to select a folder from the pair of folders or the plurality of folders so that the media content can be graphically captured into the selected folder with the computing device.

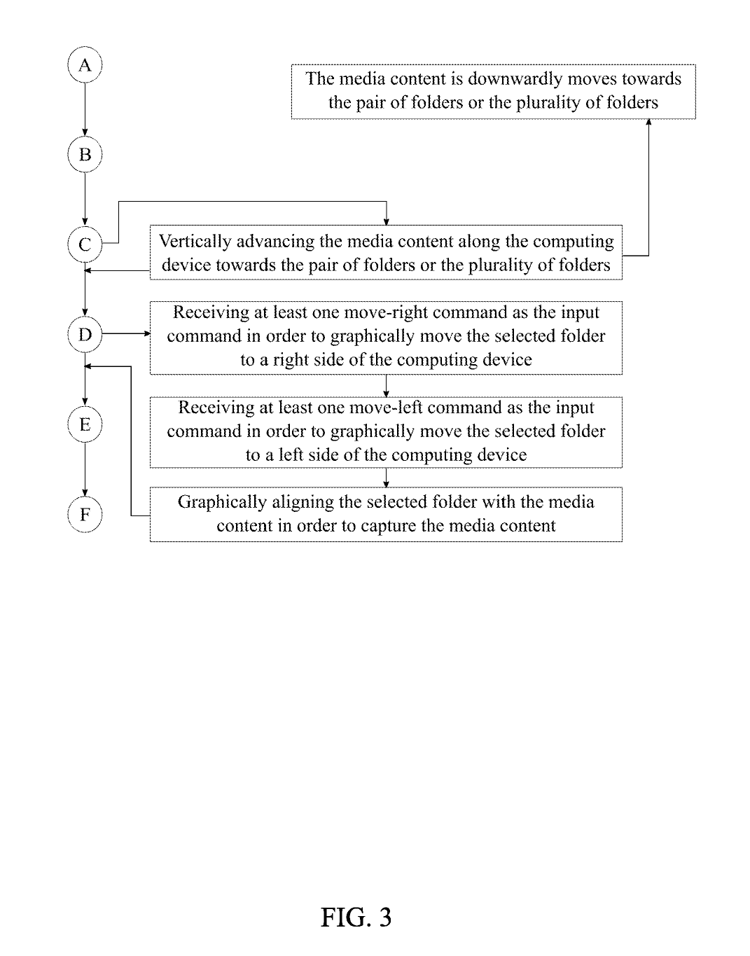

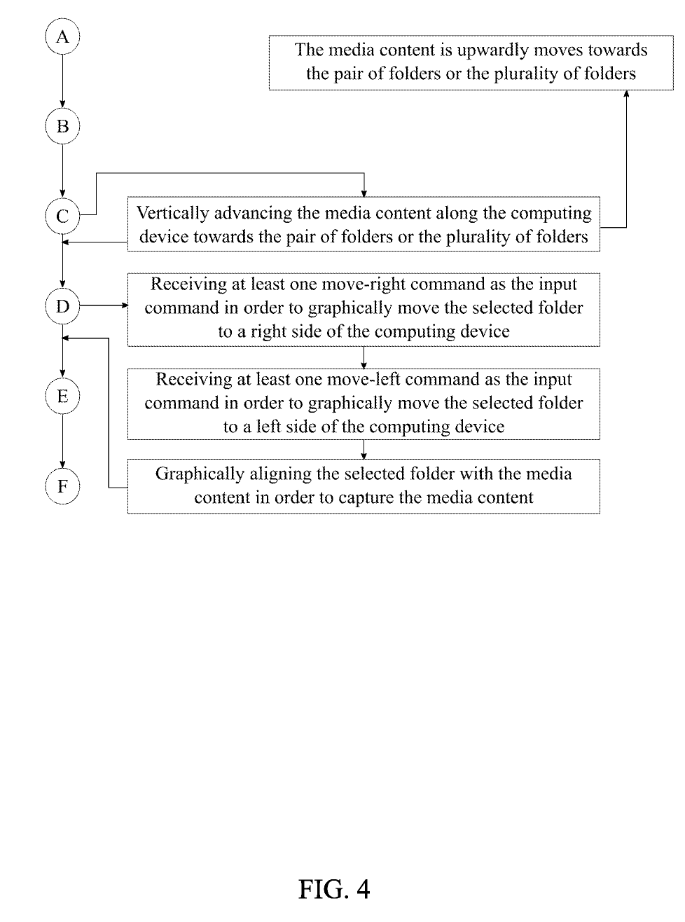

The input command and the selection of the selected folder with reference to the preferred vertical direction are shown in FIG. 1 and FIG. 3-4. More specifically, the media content vertically advances along the graphic user interface of the computing device towards the pair of folders or the plurality of folders thus clearly displaying the details of the media content to the user account. The vertical advancing of the media content can be a downward movement or an upward movement within the present invention. For examples, the media content can downwardly move towards the pair of folders or the plurality of folder that is displayed at the bottom of the graphic user interface of the computing device. Oppositely, the media content can upwardly move towards the pair of folders or the plurality of folder that is displayed at the top of the graphic user interface of the computing device. The present invention then receives the input command, which can be at least one move-right command or at least one move-left command, so that the selected folder can be graphically moved to a right side or a left side of computing device in order to align with the advancing media content, respectively. Once the selected folder is graphically aligned with the advancing media content, the present invention is able to graphically capture the media content thus completing the organization process for the respective media content. For examples, when the binary organizing process is selected, the user account can graphically and vertically align either the keep folder or the discard folder in order to capture the media content through the at least one move-right command or the at least one move-left command. When the categorized organizing process is selected, the user account can graphically and vertically align either the family-and-friend folder, the work-and-business folder, the hobby folder, the scenery folder, and the discard folder in order to capture the media content through the at least one move-right command or the at least one move-left command.

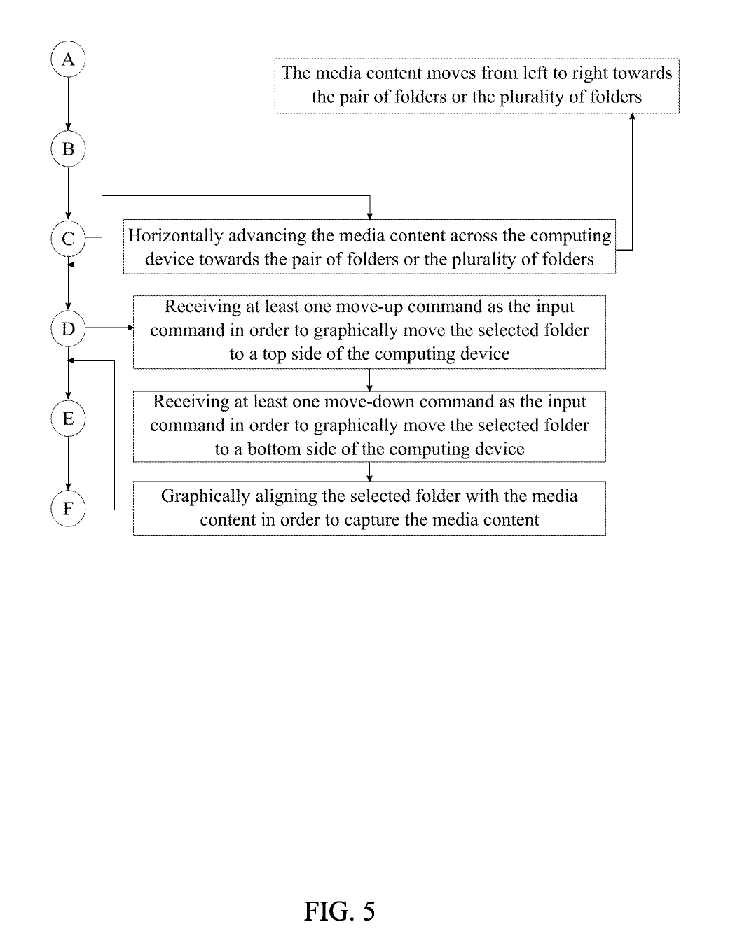

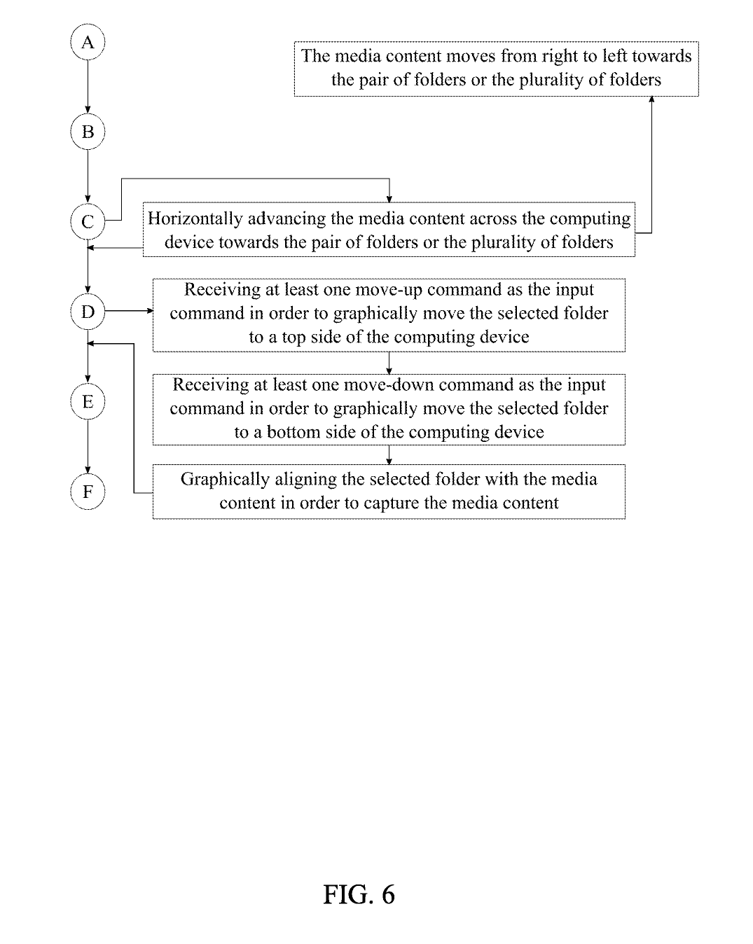

The input command and the selection of the selected folder with reference to the preferred horizontal direction are shown in FIG. 1 and FIG. 5-6. More specifically, the media content horizontally advances along the graphic user interface of the computing device towards the pair of folders or the plurality of folders thus clearly displaying the details of the media content to the user account. The horizontal advancing of the media content can be a left to right movement or a right to left movement within the present invention. For examples, the media content can move left to right towards the pair of folders or the plurality of folder that is displayed at the right side of the graphic user interface of the computing device. Oppositely, the media content can move right to left towards the pair of folders or the plurality of folder that is displayed at the left side of the graphic user interface of the computing device. The present invention then receives the input command, which can be at least one move-up command or at least one move-down command, so that the selected folder can be graphically moved to a top side or a bottom side of computing device in order to align with the advancing media content, respectively. Once the selected folder is graphically aligned with the advancing media content, the present invention is able to graphically capture the media content thus completing the organization process for the respective media content. For examples, when the binary organizing process is selected, the user account can graphically and horizontally align either the keep folder or the discard folder in order to capture the media content through the at least one move-up command or the at least one move-down command. When the categorized organizing process is selected, the user account can graphically and horizontally align either the family-and-friend folder, the work-and-business folder, the hobby folder, the scenery folder, and the discard folder in order to capture the media content through the at least one move-up command or the at least one move-down command.

In reference to FIG. 1, the aforementioned process is then repeated with the computing device in order to organize the plurality of stored media contents through the binary organizing process or the categorized organizing process. More specifically, when each of the stored media content is graphically displayed through the computing device and receives the input command, the present invention is able to graphically capture and organize each of the stored media content within the selected folder in reference to the input command.

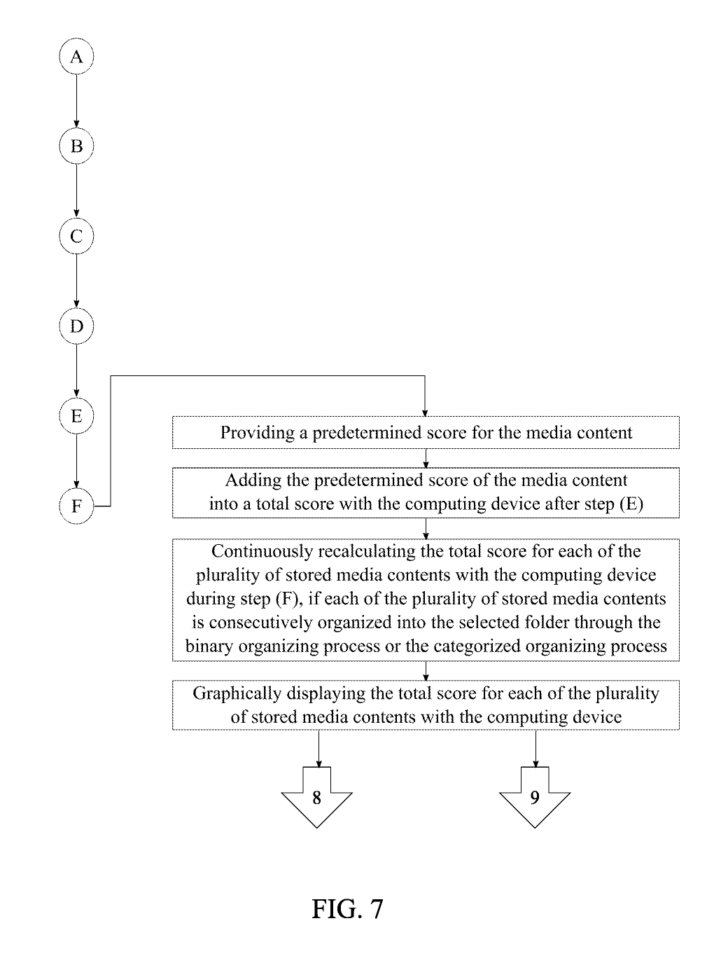

In order to create an addictive user experience, the present invention is completed with a scoring system as shown in FIG. 7. More specifically, the media content is assigned with a predetermine score so that the scoring system can be executed within the present invention. The predetermine score is preferably set to one point to offer a simplistic scoring format. After graphically capturing the media content into the selected folder, the present invention adds the predetermine score of the media content into a total score with the computing device. For examples, when the present invention graphically captures the first media content from the plurality of stored media contents, the total score displays as one point. When the present invention graphically captures the third media content from the plurality of stored media contents, the total score displays as three points. The present invention then continuously recalculates the total score for each of the plurality of stored media contents with the computing device for the rest of the plurality of stored media contents if each of the plurality of stored media contents is consecutively organized into the selected folder through the binary organizing process or the categorized organizing process. The total score is simultaneously graphically displayed for each of the plurality of stored media contents with the computing device.

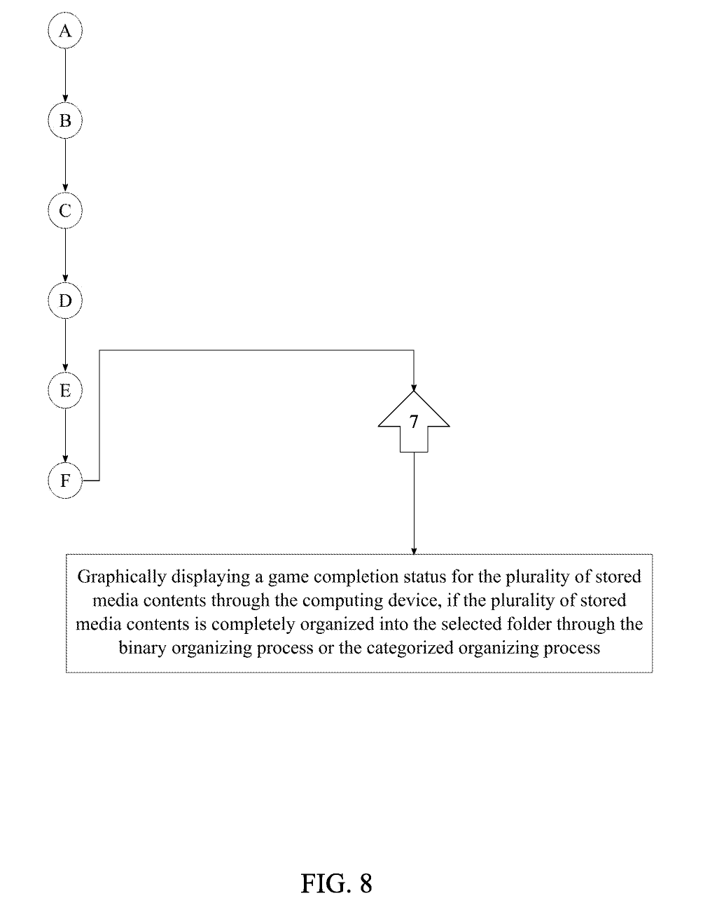

In reference to FIG. 8, when the plurality of stored media contents is completely organized into the selected folder through the binary organizing process or the categorized organizing process, the present invention graphically displays a game completion status for the plurality of stored media contents through the computing device thus concluding the present invention.

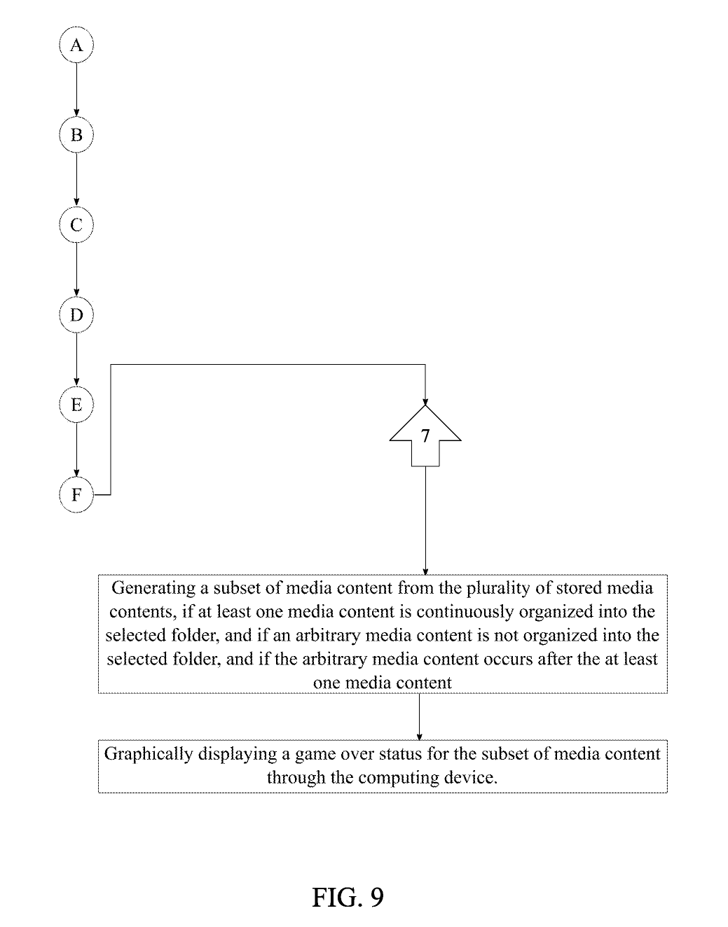

In reference to FIG. 9, the plurality of stored media contents can be partially organized into the selected folders through the binary organizing process or the categorized organizing process due to two main reasons. First, the present invention can be temporarily suspended when the user may choose not to interact with the present invention. Secondly, the present invention can be temporarily suspended when the user account is unable to organize the media content into the selected folder with reference to parameters of the binary organizing process or the categorized organizing process. More specifically, when at least one media content is continuously organized into the selected folder and an arbitrary media content is not organized into the selected folder as the arbitrary media content occurs after the at least one media content, the present invention generates a subset of media content from the plurality of stored media contents. The subset of media content includes one or more media contents that are organized through the binary organizing process or the categorized organizing process. Since the present invention is temporarily suspended, the present invention graphically displays a game over status for the subset of media content through the computing device. Alternatively, the game over status can also be displayed as a session ended status. However, when the user account interacts with the present invention after the game over status, the arbitrary media content becomes the starting points for the binary organizing process or the categorized organizing process. As a result, the user account does not have to completely restart the organizing process of the plurality of stored pictures.

Once the plurality of stored media contents is completely organized into the selected folder through the binary organizing process or the categorized organizing process, the user account can delete or keep the media contents within the discard folder. If the user account has incorrectly organized one or more stored media contents into the discard folder, the user account can correctly organize those stored media contents by reviewing them within the discard folder.

Once the plurality of stored media contents is completely organized into the selected folder through the binary organizing process or the categorized organizing process, a final score with reference to the game completion status can be posted to a social gaming network upon the acknowledgement of the user and per a privacy policy and user agreement. Resultantly, a plurality of user accounts that is wirelessly connected to the social gaming network is able to view the final score within a leaderboard of the social gaming network. Optionally, the present invention can post the amount of memory space that is freed up through the present within the leaderboard thus viewing it to the plurality of user accounts. For example, the user account allows the user to compare productivity of the final scores with their friends and associates thus encouraging them to participate in freeing up storage space on their respective computing devices, organizing their pictures and videos, and improving their long-term memory.

The input command and the selection of the selected folder with reference to an alternative vertical direction can be implemented by moving only the media content. More specifically, the media content vertically advances along the graphic user interface of the computing device towards a pair of static folders or a plurality of static folders thus clearly displaying the details of the media content to the user account. The vertical advancing of the media content can be a downward movement or an upward movement within the present invention. For examples, the media content can downwardly move towards the pair of static folders or the plurality of static folder that is displayed at the bottom of the graphic user interface of the computing device. Oppositely, the media content can upwardly move towards the pair of static folders or the plurality of static folder that is displayed at the top of the graphic user interface of the computing device. The present invention then receives the input command, which can be at least one move-right command or at least one move-left command, so that the media content can be graphically moved to a right side or a left side of computing device in order to align with the selected folder, respectively. Once the advancing media content is graphically aligned with the selected folder, the present invention is able to graphically capture the media content thus completing the organization process for the respective media content.

The input command and the selection of the selected folder with reference to an alternative horizontal direction can be implemented by moving only the media content. More specifically, the media content horizontally advances along the graphic user interface of the computing device towards the pair of static folders or the plurality of static folders thus clearly displaying the details of the media content to the user account. The horizontal advancing of the media content can be a left to right movement or a right to left movement within the present invention. For examples, the media content can move left to right towards the pair of static folders or the plurality of static folder that is displayed at the right side of the graphic user interface of the computing device. Oppositely, the media content can move right to left towards the pair of static folders or the plurality of static folder that is displayed at the left side of the graphic user interface of the computing device. The present invention then receives the input command, which can be at least one move-up command or at least one move-down command, so that the media content can be graphically moved to a top side or a bottom side of computing device in order to align with the selected folder, respectively. Once the advancing media content is graphically aligned with the selected folder, the present invention is able to graphically capture the media content thus completing the organization process for the respective media content.

Although the invention has been explained in relation to its preferred embodiment, it is to be understood that many other possible modifications and variations can be made without departing from the spirit and scope of the invention as hereinafter claimed.

What is claimed is:

1. A method for organizing pictures and videos within a computing device using an application, the method comprises the steps of:
(A) providing a computing device, wherein the computing device includes a plurality of stored media contents;
(B) prompting to select a binary organizing process or a categorized organizing process with the computing device, wherein the binary organizing process includes a pair of folders and, wherein the categorized organizing process includes a plurality of folders;
(C) graphically displaying a media content from the plurality of stored media contents with the computing device;
(D) receiving an input command for the media content in order select a folder from the pair of folders or the plurality of folders with the computing device;
(E) graphically capturing the media content into the selected folder with the computing device; and
(F) repeating steps (C) through (E) in order to organizing the plurality of stored media contents through the binary organizing process or the categorized organizing process.

2. The method for organizing pictures and videos within a computing device using an application, the method as claimed in claim 1, wherein the media content is an image file.

3. The method for organizing pictures and videos within a computing device using an application, the method as claimed in claim 1, wherein the media content is an audio-visual file.

4. The method for organizing pictures and videos within a computing device using an application, the method as claimed in claim 1, wherein the pair of folders includes a keep folder and a discard folder.

5. The method for organizing pictures and videos within a computing device using an application, the method as claimed in claim 1, wherein the plurality of folders includes a family-and-friend folder, a work-and-business folder, a hobby folder, a scenery folder, and a discard folder.

6. The method for organizing pictures and videos within a computing device using an application, the method as claimed in claim 1 comprises the steps of:
vertically advancing the media content along the computing device towards the pair of folders or the plurality of folders;
receiving at least one move-right command as the input command in order to graphically move the selected folder to a right side of the computing device;
receiving at least one move-left command as the input command in order to graphically move the selected folder to a left side of the computing device; and
graphically aligning the selected folder with the media content in order to capture the media content.

7. The method for organizing pictures and videos within a computing device using an application, the method as claimed in claim 6, wherein the media content is downwardly moves towards the pair of folders or the plurality of folders.

8. The method for organizing pictures and videos within a computing device using an application, the method as claimed in claim 6, wherein the media content is upwardly moves towards the pair of folders or the plurality of folders.

9. The method for organizing pictures and videos within a computing device using an application, the method as claimed in claim 1 comprises the steps of:
horizontally advancing the media content across the computing device towards the pair of folders or the plurality of folders;
receiving at least one move-up command as the input command in order to graphically move the selected folder to a top side of the computing device;
receiving at least one move-down command as the input command in order to graphically move the selected folder to a bottom side of the computing device; and
graphically aligning the selected folder with the media content in order to capture the media content.

10. The method for organizing pictures and videos within a computing device using an application, the method as claimed in claim 9, wherein the media content moves from left to right towards the pair of folders or the plurality of folders.

11. The method for organizing pictures and videos within a computing device using an application, the method as claimed in claim 9, wherein the media content moves from right to left towards the pair of folders or the plurality of folders.

12. The method for organizing pictures and videos within a computing device using an application, the method as claimed in claim 1 comprises the steps of:
providing a predetermined score for the media content;
adding the predetermined score of the media content into a total score with the computing device after step (E);
continuously recalculating the total score for each of the plurality of stored media contents with the computing device during step (F),
if each of the plurality of stored media contents is consecutively organized into the selected folder through the binary organizing process or the categorized organizing process; and
graphically displaying the total score for each of the plurality of stored media contents with the computing device.

13. The method for organizing pictures and videos within a computing device using an application, the method as claimed in claim 12 comprises the steps of:
graphically displaying a game completion status for the plurality of stored media contents through the computing device,
if the plurality of stored media contents is completely organized into the selected folder through the binary organizing process or the categorized organizing process.

14. The method for organizing pictures and videos within a computing device using an application, the method as claimed in claim 12 comprises the steps of:
generating a subset of media content from the plurality of stored media contents,
if at least one media content is continuously organized into the selected folder, and
if an arbitrary media content is not organized into the selected folder, and
if the arbitrary media content occurs after the at least one media content; and
graphically displaying a game over status for the subset of media content through the computing device.
